(19) United States
(12) Patent Application Publication
(10) Pub. No.: US 2023/0385488 A1
(43) Pub. Date: Nov. 30, 2023

(54) BIONIC FLOW CHANNEL DESIGN METHOD FOR ADDITIVE MANUFACTURING CYLINDER BLOCK AND HYDRAULIC DRIVE DEVICE THEREOF

(71) Applicant: Yanshan University, Qinhuangdao (CN)

(72) Inventors: Kaixian BA, Qinhuangdao (CN); Xinjie LI, Qinhuangdao (CN); Bin YU, Qinhuangdao (CN); Zhipeng HUANG, Qinhuangdao (CN); Lipeng YUAN, Qinhuangdao (CN); Qixin ZHU, Qinhuangdao (CN); Ruikang CAO, Qinhuangdao (CN); Yuepeng XU, Qinhuangdao (CN)

(21) Appl. No.: 18/320,365

(22) Filed: May 19, 2023

(30) Foreign Application Priority Data
May 31, 2022 (CN) 2022106122238

(51) Int. Cl. G06F 30/28

(52) U.S. Cl. CPC G06F 30/28; G06F 2113/10

(57) ABSTRACT

The present invention relates to a bionic flow channel design method for additive manufacturing cylinder block and its hydraulic drive device , which includes the following steps: Step 1: determine the energy required to transfer liquid through bionic flow channels; Step 2: determine the radius of the bionic flow channel; Step 3: determine the branch angle of the bionic flow channel; Step 4: determine the structure of the bionic flow channel and complete the manufacture of the hydraulic drive device.

### TECHNICAL FIELD

The present application relates to the field of additive manufacturing technology and fluid transmission technology, and more particularly relates to a bionic flow channel design method for additive manufacturing cylinder block and its hydraulic drive device.

### BACKGROUND TECHNOLOGY

Additive manufacturing is a manufacturing technology that uses computer-aided design (Solidworks, Magics) model data to stack up layer by layer according to extrusion, sintering, melting, and spraying methods to produce physical objects. Compared with traditional processing methods such as cutting, polishing, and carving, additive manufacturing technology has no restrictions on the shape of parts and can accelerate the production process of parts. The application potential is huge. Empowered by technologies such as topology optimization and creative design, additive manufacturing technology brings lightweight structure and material reduction design, as well as improved heat dissipation performance of parts, making it widely used in fields such as aerospace, foot-operated robots, etc. There is no doubt that hydraulic drive devices, as key components of foot-operated robot joint drive, have the advantages of high power-to-weight ratio, stable work and small impact during switching, large thrust, and good control performance. It is of great significance for improving the power-to-weight ratio of its components and the control performance of the system.

For the production and manufacturing of hydraulic drive devices, cylinder blocks are usually made by machining. The main disadvantages are that detailed drawings are required from the model to the production process. At the same time, the production cycle is long. Especially, the processing requirements for the hydraulic drive device flow channels are high, it is inevitable that there will be process holes on the cylinder block surface, resulting in a large number of sealing points and easy leakage failure. At the same time, for the design of traditional hydraulic drive device cylinder blocks, the cylinder block structure under traditional structure generally has a large weight and complex redundant structure, which makes it difficult to realize the development of hydraulic drive devices in the direction of lightweight and high integration. At the same time, for the complete production cycle of hydraulic drive device, the additive manufacturing method also requires less two-dimensional drawings compared to the machined production method, which greatly simplifies the design and production process of a hydraulic drive device. Therefore, in the movement of hydraulically driven high-end mobile equipment, there is an urgent need for a design method for high-performance hydraulic drive device based on additive manufacturing.

### SUMMARY OF THE INVENTION

In order to overcome the shortcomings of existing technology, the present invention further improves the work efficiency and optimizes design structure of hydraulic servo cylinder through scientific design of bionic flow channels for hydraulic drive device. At the same time, the present invention also greatly simplifies design and production process of hydraulic drive device cylinder block structure. Combined with characteristics of the additive manufacturing process, the designed hydraulic drive device is lighter in weight and higher in strength.

To achieve the above objectives, the present invention provides a bionic flow channel design method for additive manufacturing cylinder block, which includes following steps:

Step 1: Determine the Energy Required to Transfer Liquid through a Bionic Flow Channel;

According to the relationship between bionic flow channel flow rate q and channel diameter d, determine the energy required to transfer liquid in the channel according to the law of conservation of energy:

$$E = {E}_{f} + {E}_{m} = \frac{128 μ l {q}^{2}}{π {d}^{4}} + \frac{m l π {d}^{2}}{4} ;$$

Where: E represents the total energy consumed by the flow channel; E_{f} represents the energy required to maintain liquid flow in the flow channel; Eₘ represents the energy required to maintain metabolism; q represents flow rate in bionic flow channel; l represents length of horizontal direction of flow channel before branching; μ represents hydraulic viscosity coefficient; m represents metabolic constant; d represents diameter of bionic flow channel;

### Step 2: Determine the Radius of the Bionic Flow Channel;

With energy conservation, when the flow channel branches, the relationship between the radius of the flow channel before branching and the radiuses of two branches of the flow channel after branching is calculated as follows:

r³=r₁³+r₂³;
where: r represents the radius of the flow channel before branching; r₁ represents the radius of the first flow channel after branching; r₂ represents the radius of the second flow channel after branching;

### Step 3: Determine the Branch Angle of the Bionic Flow Channel;

the branch angle of the bionic flow channel is the angle between the center line of the flow channel before branching and the center line of any branch of the flow channel after branching, satisfying the calculation relationship between the length of the flow channel before branching I and the length of the first flow channel after branching I₁, which is shown as follows:

$$\{ \begin{matrix}I = l - H / tg θ \\ {I}_{1} = l - H / sin θ\end{matrix}$$

where: H represents the vertical distance between the center point of the flow channel after branching and the center point of the flow channel before branching; θ represents the angle between the center line of the flow channel before branching and the center line of the flow channel of any branch after branching; I represents the length of the flow channel before branching; I₁ represents the length of the first flow channel after branching;
the calculation relationship between total energy consumption E of the flow channel and angle θ between the center line of the flow channel before branching and the center line of any branch of the flow channel after branching is shown as follows:

$$E = E ( r , {r}_{1} , θ ) = ( \frac{k {q}^{2}}{{r}^{4}} + {k}_{1} {r}^{α} ) \cdot ( \frac{{L}_{z} - H}{tan θ} ) + ( \frac{k {q}_{1}^{2}}{{r}_{1}^{4}} + {k}_{1} {r}_{1}^{α} ) \cdot 2 ( \frac{{L}_{z} - H}{sin θ} ) ;$$

where: k represents the constant of the flow channel before branching; k₁ represents the constant of first flow channel after branching; L_{z} represents the total length of the flow channel in horizontal direction before and after branching; α represents number of channel branches;
when energy consumption is minimized, the calculation relationship of the branch angle of the flow channel can be obtained as follows:

$$cos θ = 2 {( \frac{r}{{r}_{1}} )}^{- 4} = {2}^{\frac{α - 4}{α + 4}} ;$$

according to the above formula, the value of angle after branching of the flow channel can be finally obtained;

### Step 4: Determine the Structure of the Bionic Flow Channel and Complete the Manufacture of the Hydraulic Drive Device;

determine the structure of the bionic flow channel according to the radius of the bionic flow channel and the branch angle of the bionic flow channel determined in Step 2 and Step 3, and process the hydraulic drive device according to the structure of the bionic flow channel.

Preferably, the acquisition method of the bionic flow channel flow rate in step 1 is shown as follows:
according to the principle of minimum energy consumption and the energy consumption relationship required to transfer liquid in step 1, the following calculation relationship is obtained:

$${q}^{2} = \frac{m {π}^{2} {d}^{6}}{2560 μ} ;$$

the hydraulic viscosity coefficient μ and metabolic constant m have been determined, so the calculation formula for flow rate in the flow channel and channel diameter can be simplified as follows:

q=kd³.

The second aspect of the present invention is that it proposes an additive manufacturing hydraulic drive device manufactured and formed according to the aforementioned bionic flow channel design. The hydraulic drive device includes a servo cylinder, a servo valve, a sensor component, a motion controller, and an end cap;
the servo cylinder includes surface reinforcement ribs, servo valves, servo valve mounting base, and end cap connecting blocks; the cylinder block of the servo cylinder is integrally provided with oil inlet bionic flow channels, oil return bionic flow channels, rod cavity bionic flow channels and rodless cavity bionic flow channels;
the servo valve is a nozzle baffle servo valve, and the servo valve is installed on the base of the servo valve cylinder block; the oil inlet of the nozzle baffle servo valve is connected to the oil inlet through the attached channel on the cylinder wall; the first control port of the nozzle baffle servo valve is connected to the rodless cavity of the cylinder block through the attached flow channel on the cylinder wall; the second control port of the nozzle baffle servo valve is connected to the rod cavity of the cylinder block through the attached channel on the cylinder wall; the oil return port of nozzle baffle servo valve is connected to oil return port through the attached flow channel on the cylinder wall;
the sensor component includes the force sensor and displacement sensor; the force sensor is installed at top of piston rod; the displacement sensor is fixed at bottom of cylinder and connected to the front end of the force sensor; the force sensor and the displacement sensor are connected to motion controller for communication; the force sensor is used to collect force output value of hydraulic drive device, and the displacement sensor is used to collect displacement value of the hydraulic drive device;
the end cap is connected to the end cap connecting block.

Preferably, the hydraulic drive device is processed by additive manufacturing technology.

Preferably, four sides of the servo valve mounting base are arc-shaped, and four corners of the servo valve are fixed on the servo valve mounting base with bolts.

Preferably, the bionic flow channels on both sides of the cylinder block of the servo cylinder are embedded inside the side wall of the servo cylinder block.

Compared with the prior art, the beneficial effects of the present invention are:
(1) The bionic flow channel design method proposed by the present invention realizes high-density integration of multiple components, small volume and lightweight, and uses bionic flow channels to realize the connection between the servo cylinder and the nozzle baffle servo valve without setting connection channels, realizing no external flow channels between the nozzle baffle servo valve and the servo cylinder, reducing the incidence of damage to the flow channel joints and leakage failure of high-end mobile equipment;
(2) The servo cylinder bionic flow channel of the present invention includes an oil inlet bionic flow channel, a rodless cavity bionic flow channel, a rod cavity bionic flow channel, and an oil return bionic flow channel, which can meet various hydraulic requirements. At the same time, the present invention also greatly simplifies the design and production process of hydraulic drive device cylinder block structure; Combined with the characteristics of additive manufacturing technology, the designed hydraulic drive device is lighter in weight and higher in strength, and can be applied to various scenarios and environments.
(3) The radius of bionic flow channels is designed for hydraulic channels during branching, the radius relationship is also applicable to symmetrical and asymmetrical branching, as well as the branching problem of circular flow channels, thus providing direction for the design of our oil bionic flow channels;
(4) The manufacture of hydraulic drive devices in the present invention is specifically completed by processing and forming through additive manufacturing technology. According to needs, the printing angle can be adjusted to reduce the difficulty of later model processing. Moreover, by optimizing the surface structure of the servo cylinder through bionic flow channels, the rigidity of the cylinder block can be further improved and the overall weight of the cylinder block can be further reduced. By designing local reinforcement rib structures, the structure of servo cylinder block is strengthened.

### BRIEF DESCRIPTION OF THE DRAWINGS

FIG. 1 is a flowchart of the bionic flow channel design method for additive manufacturing cylinder block provided by an embodiment of the present invention;

FIG. 2 is a cross-sectional view of a hydraulic drive device under additive manufacturing provided by an embodiment of the present invention;

FIG. 3 is a top view of a servo cylinder of a hydraulic drive device under additive manufacturing provided by an embodiment of the present invention;

FIG. 4 is a front view of a servo cylinder of a hydraulic drive device under additive manufacturing provided by an embodiment of the present invention;

FIG. 5 shows the pressure loss of different types of bionic flow channels provided by an embodiment of the present invention.

1, nozzle baffle servo valve; 2, additive manufacturing cylinder block; 3, motion controller; 4, piston rod; 5, force sensor; 6, hydraulic drive device ear; 7, displacement sensor; 8, oil inlet bionic flow channel; 9, oil return bionic flow channel; 10, rodless cavity bionic flow channel; 11, servo valve mounting base; 12, rod cavity bionic flow channel; 13, end cover connecting block; 14, rotating oil distribution structure.

### DETAILED DESCRIPTION OF THE PREFERRED EMBODIMENTS

Hereinafter, the embodiments of the present invention will be described with reference to the accompanying drawings.

The present invention improves the working efficiency of hydraulic servo cylinders and optimizes the design structure by designing bionic flow channels for hydraulic drive devices. It uses bionic flow channels to realize the connection between additive manufacturing cylinder block 2 and nozzle baffle servo valve 1, without the need for additional connection channels, reducing the damage of channel joints and leakage failure rate; at the same time, the present invention also greatly simplifies the structural design and production process of additive manufacturing cylinder block 2, making the designed hydraulic drive device lighter in weight and higher in strength.

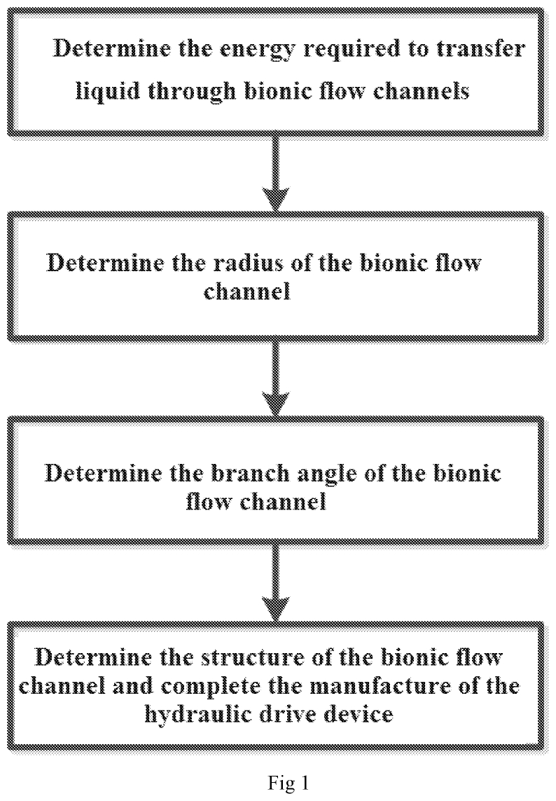

The bionic flow channel design method for additive manufacturing cylinder block 2 and hydraulic drive device provided by an embodiment of the present invention is shown in FIG. 1 as a flowchart of the bionic flow channel design method for additive manufacturing cylinder block 2 of the present invention; in order to prove the applicability of the present invention, it is applied to an example, which specifically includes the following steps:

S1: Determine the Energy Required to Transfer Liquid through Bionic Flow Channels;
according to the relationship between bionic flow channel flow rate q and channel diameter d, determine the energy required to transfer liquid in the channel according to the law of conservation of energy:

$$E = {E}_{f} + {E}_{m} = \frac{128 μ l {q}^{2}}{π {d}^{4}} + \frac{m l π {d}^{2}}{4} ;$$

where: E represents the total energy consumed by the flow channel; E_{f} represents the energy required to maintain liquid flow in the flow channel; Eₘ represents the energy required to maintain metabolism; q represents flow rate in bionic flow channel; l represents length of horizontal direction of flow channel before branching; μ represents hydraulic viscosity coefficient; m represents metabolic constant; d represents diameter of bionic flow channel.

### S2: Determine the Radius of the Bionic Flow Channel;

Obtain the energy consumption relationship required to transfer liquid in S1, and according to the minimum energy consumption principle, the following calculation relationship can be obtained:

$${q}^{2} = \frac{m {π}^{2} {d}^{6}}{2560 μ} ;$$

The hydraulic viscosity coefficient μ and metabolic constant m have been determined, so the calculation formula for flow rate in the flow channel and channel diameter can be simplified as follows:

q=kd³;
where: k represents the constant of the flow channel before branching;

Under the premise of energy conservation, if there is a branch in the flow channel, the calculation relationship of the channel radius is shown as follows:

r³=r₁³+r₂³;
where: r represents the radius of the flow channel before branching; r₁ represents the radius of the first flow channel after branching; r₂ represents the radius of the second flow channel after branching;

### S3: Determine the Branch Angle of the Bionic Flow Channel;

After branching of flow channel, the calculation relationship between the length of flow channel before branching I and the length of flow channel after branching I₁ is shown as follows:

$$\{ \begin{matrix}I = l - H / tg θ \\ {I}_{1} = l - H / sin θ\end{matrix} ;$$

where: H represents the vertical distance between the center point of the flow channel after branching and the center point of the flow channel before branching; θ represents the angle between the center line of the flow channel before branching and the center line of the flow channel of any branch after branching; I represents the length of the flow channel before branching; I₁ represents the length of the flow channel after branching;

The calculation relationship between total energy consumption E of the flow channel and angle θ between center lines of the two flow channels before and after branching is shown as follows:

$$E = E ( r , {r}_{1} , θ ) = ( \frac{k {q}^{2}}{{r}^{4}} + {k}_{1} {r}^{α} ) \cdot ( \frac{{L}_{z} - H}{tan θ} ) + ( \frac{k {q}_{1}^{2}}{{r}_{1}^{4}} + {k}_{1} {r}_{1}^{α} ) \cdot 2 ( \frac{{L}_{z} - H}{sin θ} ) ;$$

where: k₁ represents the constant of first flow channel after branching; L_{z} represents total length of the flow channel in horizontal direction before and after branching; α represents number of channel branches;
when energy consumption is minimized, the calculation relationship of the branch angle of the flow channel can be obtained as follows:

$$cos θ = 2 {( \frac{r}{{r}_{1}} )}^{- 4} = {2}^{\frac{α - 4}{α + 4}} ;$$

According to the above formula, the range of angle after branching of the flow channel can be finally obtained.

### S4: Determine the Structure of the Bionic Flow Channel and Complete the Manufacture of the Hydraulic Drive Device;

determine the structure of the bionic flow channel according to the radius of the bionic flow channel and the branch angle of the bionic flow channel determined in S2 and S3, and process the hydraulic drive device according to the structure of the bionic flow channel.

The bionic flow channel is a flow channel layout based on a Bessel curve arrangement, i.e. based on the bionic concept, with reference to the flow channel branching and energy-saving perspective of the cardiac vascular system. It also includes the energy required for blood flow and the energy required to maintain metabolism, and is designed in such a way that the least amount of energy is consumed during blood transfer.

As shown in Table 1, a comparison of the pressure loss at different transition methods is obtained from the simulation. From the table, it can be seen that the traditional flow channel transition can be divided into linear transition and circular transition, while the invention is based on Bessel curve bionic flow channel, from the data in the table, it can be known that the present application can greatly reduce the pressure loss caused by the change of direction and transition of liquid in the flow channel. The advantages of the flow channel layout proposed by the present invention can be seen more intuitively through quantitative analysis of the pressure losses with several different transition models, setting the same liquid properties and boundary conditions.

TABLE 1
Comparison of pressure loss at different transition methods
obtained from simulation

| | | | | | Percentage |
|---|---|---|---|---|---|
| | | | | | reduction in |
| | | | | | pressure loss |
| | | Inlet | Outlet | | compared |
| Boundary | Model | pressure/ | pressure/ | Pressure | to linear |
| conditions | type | MPa | MPa | loss/MPa | transition/% |
| 10 m/s | linear | 10.4 | 10 | 0.4 | |
| | R = 5 | 10.314 | 10 | 0.314 | 21.5 |
| | R = 10 | 10.29 | 10 | 0.29 | 27.5 |
| | R = 20 | 10.265 | 10 | 0.265 | 33.75 |
| | YT1 | 10.227 | 10 | 0.227 | 43.25 |
| | YT2 | 10.22 | 9.99 | 0.23 | 42.5 |

The radius of bionic flow channels is used in the branching design of the hydraulic channels, in order to avoid greater pressure loss during oil transfer due to large corner flow channels, the radius relationship is also applicable to symmetrical and asymmetrical branching, as well as the branching problem of circular flow channels, thus providing direction for the design of our oil bionic flow channels;

After obtaining the above-mentioned channel radius, under the premise of minimum energy consumption in the flow channel, the geometric relationships of the flow channel after branching is used to determine the range of angle after branching, the angle of the flow channel also applies to the channel design that does not start at the same point but the center lines of the flow channel intersect. Finally, the design of bionic flow channels can be achieved by following the principles of flow channel radius and flow channel branch angle, using structural characteristics.

The second aspect of the present invention proposes an additive manufacturing hydraulic drive device designed according to bionic flow channels, which can be set on the additive manufacturing cylinder block 2 by a flow channel optimization design and an additive manufacturing process, acting as a reinforcement rib and minimizing the wall thickness of the servo cylinder after optimization. The hydraulic drive device mainly includes nozzle baffle servo valve 1, additive manufacturing cylinder block 2, motion controller 3, piston rod 4, force sensor 5, hydraulic drive device ear 6, displacement sensor 7, oil inlet bionic flow channel 8, oil return bionic flow channel 9, rodless cavity bionic flow channel 10, servo valve mounting base 11, rod cavity bionic flow channel 12, end cover connecting block 13 and rotating oil distribution structure 14.

As shown in FIG. 3, considering actual working conditions, during the movement of the hydraulic drive device, the additive manufacturing cylinder block 2 is mainly subjected to pressure and annular stress generated by contact between piston rod 4 and additive manufacturing cylinder block 2. The pressure generated inside additive manufacturing cylinder block 2 mainly enters into the cavity by the nozzle baffle servo valve 1 from the rear end of the cylinder block through the oil inlet bionic flow channel 8. In addition to exerting a certain pressure on additive manufacturing cylinder block 2, this part of oil can also push the piston rod 4 forward. The influence of frictional force generated during movement on strength of additive manufacturing cylinder block 2 can be ignored. Motion controller 3 is used to control movement process of hydraulic drive device.

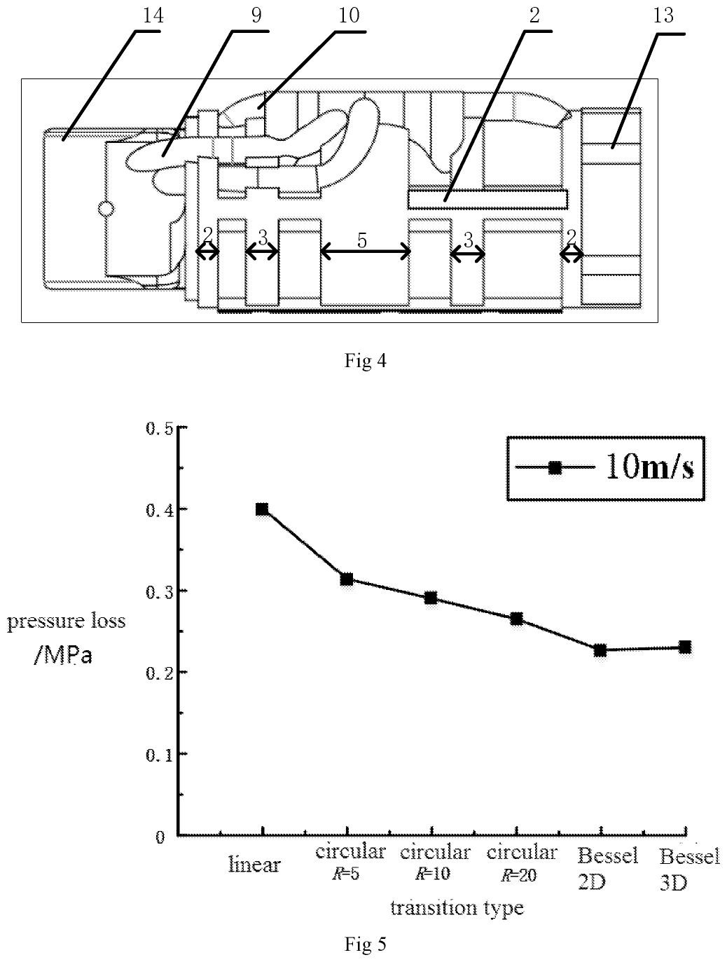

As shown in FIG. 4, on the basis of ensuring the minimum wall thickness of additive manufacturing cylinder block 2, it is evenly distributed on the surface of additive manufacturing cylinder block 2 at a ratio of 2:3:5 under a certain length of cylinder block. This distribution rule mainly considers that during the process of oil pushing the piston to move, the force received by rotating oil distribution structure 14 and end cover connecting block 13 is small, and the speed is slow during movement, and the impact on the cylinder block is not great. Similarly, in the middle position of the cylinder block, the pressure of oil in the cylinder block increases as the amount of oil in the cavity increases, and when piston rod 4 moves within this range, it causes a greater impact on this area. Therefore, an annular reinforcement rib is applied at this position.

The bionic flow channel on the surface of additive manufacturing mainly considers the spatial layout of the surface of the additive manufacturing cylinder block 2. Compared with the channel layout under traditional processing, for two positions that are not in the same plane, additive manufacturing flow channel can realize flow channel connection with a certain degree of curvature, avoiding the phenomenon of vortex flow at the intersection due to excessive corner under the traditional vertical intersection, greatly reducing the energy loss of oil in the pipeline.

As shown in FIG. 3, on surface of additive manufacturing cylinder block 2, rodless cavity bionic flow channel 10 is the servo cylinder oil inlet. In order to overcome energy transfer efficiency problem caused by small inner diameter of flow channel, the flow channel branching theory is used. While combined with FIG. 4, it can be seen that at the corner of rodless cavity bionic flow channel 10, an arc-shaped pipe with a certain bending radius is used for connection to avoid the generation of vortex flow at the corner. Similarly, rod cavity bionic flow channel 12 is the servo cylinder oil return port, and the design principle thereof can refer to relevant content of rodless cavity bionic flow channel 10.

As shown in FIG. 4, bionic flow channels on both sides of cylinder block are mainly oil inlet bionic flow channel 8 and oil return bionic flow channel 9 for the nozzle baffle servo valve 1. Since this part of channel needs to connect the oil inlet and oil return port of the rotating oil distribution structure 14 and servo valve mounting base 11 that are not in the same plane, therefore during the design process of flow channel, arc-shaped pipes with certain bending radius are used at the starting point and the endpoint to lead the flow channel out to a same plane. The middle part is connected by straight pipe. Based on reducing the length of flow channel, it greatly reduces the vortex scene caused by vertical connection and improves the energy utilization rate of nozzle baffle servo valve 1.

As shown in FIG. 4, bionic flow channels on both sides of cylinder block are embedded into additive manufacturing cylinder block 2 to restrict transverse deformation of cylinder block. Both reduce wall thickness and prevent transverse deformation of cylinder block, which greatly optimizes the weight of the cylinder block.

The pressure loss of different types of bionic flow channels provided by an embodiment of the present invention is shown in FIG. 5. The pressure loss of linear transition is the largest, and the pressure loss of circular transition and Bezier transition is smaller, mainly concentrated between 0.2 MPa-0.3 MPa, and as the circular radius increases, the pressure loss gradually decreases. The pressure loss of flow channels using different forms of Bezier curves is reduced by 40%-45% compared to linear flow channels. The flow channel layout proposed by the present invention obviously reduces the pressure loss of the flow channel and improves the flow characteristics of oil in the flow channel.

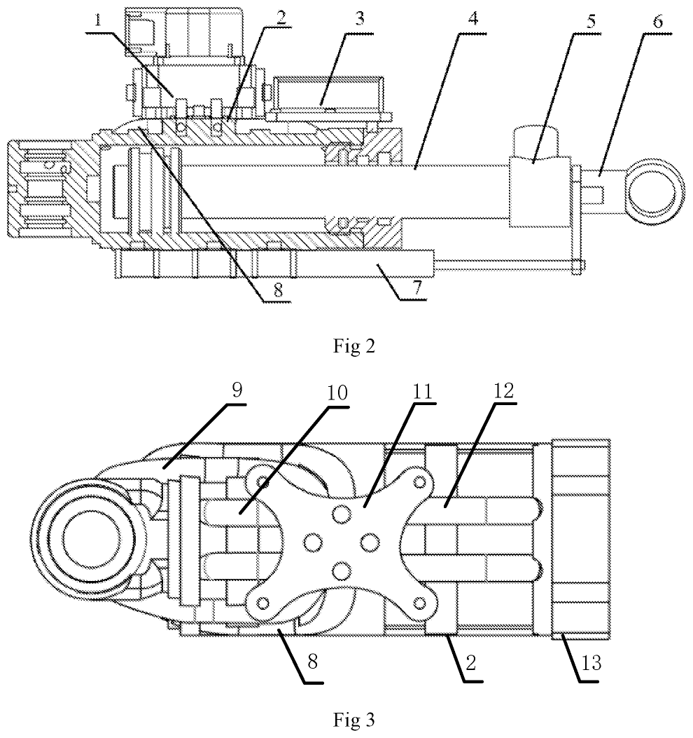

As shown in FIG. 2, nozzle baffle servo valve 1 is mainly installed on servo valve mounting base 11. The servo valve needs to be fixed with bolts on all sides, so as long as the installation size of the servo valve is guaranteed, the four sides of servo valve mounting base 11 are designed for lightweight, replacing original square plane with arc curve connection, greatly reducing weight of servo valve mounting base 11.

The manufacture of hydraulic drive device is specifically formed by additive manufacturing technology, taking into account process characteristics, selecting appropriate printing angle, and designing the parts that may produce support structure in cylinder structure, adjusting printing angle for sliced surface and the structure added from the supporting part to reduce difficulty of later model processing; optimizing the surface structure of additive manufacturing cylinder block 2 through bionic flow channels to improve cylinder block rigidity and reduce overall weight of cylinder block. By designing a local reinforcement rib structure, the reliability of additive manufacturing cylinder block 2 is strengthened.

In summary, the bionic flow channel design method for additive manufacturing cylinder block 2 and the hydraulic drive device of the present application have proven to have good application effects , as follows:
(1) The bionic flow channel design method proposed by the embodiment of the present invention realizes high-density integration of multiple components, small volume, and lightweight, and uses bionic flow channels to realize connection between additive manufacturing cylinder block 2 and nozzle baffle servo valve 1 without setting connection channels, realizing no external flow channels between additive manufacturing cylinder block 2 and nozzle baffle servo valve 1, reducing the incidence of damage to the flow channel joints and leakage failure of high-end mobile equipment;
(2) The hydraulic drive device proposed by the embodiment of the present invention is based on bionic flow channels for additive manufacturing, which greatly simplifies design and production process of the cylinder block structure of hydraulic drive device. Combined with the characteristics of the additive manufacturing process, the designed hydraulic drive device is lighter in weight and higher in strength.

The embodiments described above are only a description of the preferred embodiment of the present invention and are not intended to limit the scope of the present invention. Without departing from the spirit of the design of the present invention, various variations and improvements made to the technical solutions of the present invention by persons of ordinary skill in the art shall fall within the scope of protection determined by the claims of the present invention.

What is claimed is:

1. A bionic flow channel design method for additive manufacturing cylinder block, comprising:
Step 1: determine the energy required to transfer liquid through a bionic flow channel;
according to the relationship between bionic flow channel flow rate q and channel diameter d, determine the energy required to transfer liquid in the channel according to the law of conservation of energy:
$$E = {E}_{f} + {E}_{m} = \frac{128 μ l {q}^{2}}{π {d}^{4}} + \frac{m l π {d}^{2}}{4} ;$$
where: E represents the total energy consumed by the flow channel; E_{f} represents the energy required to maintain liquid flow in the flow channel; Eₘ represents the energy required to maintain metabolism; q represents flow rate in bionic flow channel; l represents length of horizontal direction of flow channel before branching; μ represents hydraulic viscosity coefficient; m represents metabolic constant; d represents diameter of bionic flow channel;
Step 2: determine the radius of the bionic flow channel;
with energy conservation, when the flow channel branches, the relationship between the radius of the flow channel before branching and the radiuses of two branches of the flow channel after branching is calculated as follows:
r³=r₁³+r₂³;
where: r represents the radius of the flow channel before branching; r₁ represents the radius of the first flow channel after branching; r₂ represents the radius of the second flow channel after branching;
Step 3: determine the branch angle of the bionic flow channel;
the branch angle of the bionic flow channel is the angle between the center line of the flow channel before branching and the center line of any branch of the flow channel after branching, satisfying the calculation relationship between the length of the flow channel before branching I and the length of the first flow channel after branching I₁, which is shown as follows:
$$\{ \begin{matrix}I = l - H / tg θ \\ {I}_{1} = l - H / sin θ\end{matrix}$$
where: H represents the vertical distance between the center point of the flow channel after branching and the center point of the flow channel before branching; θ represents the angle between the center line of the flow channel before branching and the center line of the flow channel of any branch after branching; I represents the length of the flow channel before branching; I₁ represents the length of the first flow channel after branching;
the calculation relationship between total energy consumption E of the flow channel and angle θ between the center line of the flow channel before branching and the center line of any branch of the flow channel after branching is shown as follows:
$$E = E ( r , {r}_{1} , θ ) = ( \frac{k {q}^{2}}{{r}^{4}} + {k}_{1} {r}^{α} ) \cdot ( \frac{{L}_{z} - H}{tan θ} ) + ( \frac{k {q}_{1}^{2}}{{r}_{1}^{4}} + {k}_{1} {r}_{1}^{α} ) \cdot 2 ( \frac{{L}_{z} - H}{sin θ} ) ;$$
where: k represents the constant of the flow channel before branching; k₁ represents the constant of first flow channel after branching; L_{z} represents total length of the flow channel in horizontal direction before and after branching; α represents number of channel branches;
when energy consumption is minimized, the calculation relationship of the branch angle of the flow channel can be obtained as follows:
$$cos θ = 2 {( \frac{r}{{r}_{1}} )}^{- 4} = {2}^{\frac{α - 4}{α + 4}} ;$$
according to the above formula, the value of angle after branching of the flow channel can be finally obtained;
Step 4: determine the structure of the bionic flow channel and complete the manufacture of the hydraulic drive device;
determine the structure of the bionic flow channel according to the radius of the bionic flow channel and the branch angle of the bionic flow channel determined in Step 2 and Step 3, and process the hydraulic drive device according to the structure of the bionic flow channel.

2. The bionic flow channel design method for additive manufacturing cylinder block according to claim 1, wherein acquisition method of the bionic flow channel flow rate in the Step 1 is shown as follows:
according to the principle of minimum energy consumption and the energy consumption relationship required to transfer liquid in step 1, the following calculation relationship is obtained:
$${q}^{2} = \frac{m {π}^{2} {d}^{6}}{2560 μ} ;$$
the hydraulic viscosity coefficient μ and metabolic constant m have been determined, so the calculation formula for flow rate in the flow channel and channel diameter can be simplified as follows:
q=kd³.
